(19) United States
(12) Patent Application Publication
(10) Pub. No.: US 2018/0350292 A1
(43) Pub. Date: Dec. 6, 2018

(54) DISPLAY APPARATUS AND DISPLAY METHOD THEREOF

(71) Applicants: QINGDAO HISENSE ELECTRONICS CO., LTD., Qingdao (CN); HISENSE INTERNATIONAL CO., LTD., Qingdao (CN); HISENSE USA CORPORATION, Suwanee, GA (US)

(72) Inventors: XIANCE MENG, QINGDAO (CN); SHENGFENG HONG, QINGDAO (CN); JUNYU LUO, QINGDAO (CN)

(21) Appl. No.: 15/895,973

(22) Filed: Feb. 13, 2018

(30) Foreign Application Priority Data
Jun. 2, 2017 (CN) 201710407870.4

(51) Int. Cl. G09G 3/20; G06F 3/14; G06T 11/60

(52) U.S. Cl. CPC G09G 3/2092; G09G 2380/08; G06T 11/60; G06F 3/1423

(57) ABSTRACT

The present application provides a display apparatus and a display method thereof, wherein the display apparatus includes a display screen, and further includes a fixing component, a positioning sensor, and a display processor; wherein the fixing component is configured to fix an to-be-exhibited object on the display screen; the positioning sensor is configured to detect a position of the fixing component on the display screen; the display processor is configured to determine a first area corresponding to the fixing component on the display screen according to the position detected by the positioning sensor, and switch an image displayed in the first area to a white image, wherein the first area includes an area on the display screen for placing the to-be-exhibited object.

### CROSS-REFERENCE TO RELATED APPLICATION

This application claims priority to Chinese Patent Application No. 201710407870.4, filed with the Chinese Intellectual Property Office on Jun. 2, 2017, entitled “Display apparatus and Display Method thereof”, which is incorporated herein by reference in its entirety.

### FIELD OF THE TECHNOLOGY

The present application relates to the field of medical devices, and in particular, to a display apparatus and a display method thereof.

### BACKGROUND

With the tendency that the medical image becomes digitized, there are more and more display devices in medical diagnostic devices. The current film reading method is to read a digital images displayed on the medical diagnostic display and to read a film in a comparative manner to perform a hybrid film reading. At present, in order to facilitate a medical worker to view both a digital image and a traditional medical film by using a same diagnostic display, a light box mode is usually set on the display. When it is needed to view the medical film, the medical worker reads film by operating a key to switch a screen display content to a white image, simultaneously adjusting a backlight brightness as required, and then placing the film on the display. When it is needed to view a digital image, the medical worker reads the digital image by exiting the light box mode by operating the key to enable the display to normally display the digital image. However, when using this device, it needs to switch back and forth through the key operation, the operation is cumbersome.

### SUMMARY

The display apparatus of the present application includes: a fixing component, a positioning sensor, and a display processor; where

the fixing component is configured to fix a to-be-exhibited object on a display screen;

the positioning sensor is configured to detect a position of the fixing component on the display screen;

the display processor is configured to determine a first area corresponding to the fixing component on the display screen, according to the position detected by the positioning sensor, and switch an image displayed in the first area to a white image, wherein the first area includes an area on the display screen for placing the to-be-exhibited object.

A display method of the present application, which is applicable to the above display apparatus, includes:

detecting a fixing component by a positioning sensor, and determining a position of the fixing component on the display screen, wherein the fixing component is configured to fix a to-be-exhibited object on the display screen;

determining a first area corresponding to the fixing component on the display screen according to the determined position, wherein the first area includes an area on the display screen for placing the to-be-exhibited object;

switching an image displayed in the first area to a white image based on the first area.

### BRIEF DESCRIPTION OF THE DRAWINGS

In order to make technical solutions in embodiments of the present application clearer, in the following, accompanying drawings needed to be used in the description of the embodiments will be briefly described. Apparently, the described drawings are merely some embodiments of present application. For persons skilled in the art, other drawings may be obtained based on these drawings without any creative effort.

FIG. 1 is a schematic diagram of a display with light box mode in the related art;

FIG. 2 is another schematic diagram of a display with light box mode in the related art;

FIG. 3 is a schematic structural diagram of composition of a display portion of a display apparatus according to some embodiments of the present application;

FIG. 4 is a schematic structural diagram of a fixing component according to some embodiments of the present application;

FIG. 5 is a schematic structural diagram of a positioning sensor according to some embodiments of the present application;

FIG. 6 is a schematic operation principle diagram of a positioning sensor according to some embodiments of the present application;

FIG. 7 is a schematic structural diagram of a positioning sensor according to some embodiments of the present application;

FIG. 8 is a schematic operation principle diagram of a positioning sensor according to some embodiments of the present application;

FIG. 9 is a flowchart of a display method according to some embodiments of the present application;

FIG. 10 is a flowchart of a display method according to some embodiments of the present application.

FIG. 11 is a schematic operation diagram of a display apparatus according to the display method shown in FIG. 10 placing a fixing component without an to-be-exhibited object thereon;

FIG. 12 is a schematic operation diagram of a display apparatus according to the display method shown in FIG. 10 after placing a fixing component with the to-be-exhibited object thereon;

FIG. 13 is another schematic operation diagram of a display apparatus according to the display method shown in FIG. 10 placing a fixing component without an to-be-exhibited object thereon;

FIG. 14 is another schematic operation diagram of a display apparatus according to the display method shown in FIG. 10 after placing a fixing component with the to-be-exhibited object thereon;

FIG. 15 is a flowchart of a display method according to some embodiments of the present application.

FIG. 16 is a schematic operation diagram of a display apparatus according to the display method shown in FIG. 15 placing a fixing component without an to-be-exhibited object thereon; and

FIG. 17 is a schematic operation diagram of a display apparatus according to the display method shown in FIG. 15 after placing a fixing component with the to-be-exhibited object thereon display apparatus display apparatus.

### DETAILED DESCRIPTION

In order to make technical solutions in embodiments of the present application clearer, in the following, accompanying drawings needed to be used in the description of the embodiments will be briefly described. Apparently, the described drawings are merely some embodiments of present application. For persons skilled in the art, other drawings may be obtained based on these drawings without any creative effort.

The related art below just informations related to the present application which is not necessarily prior art.

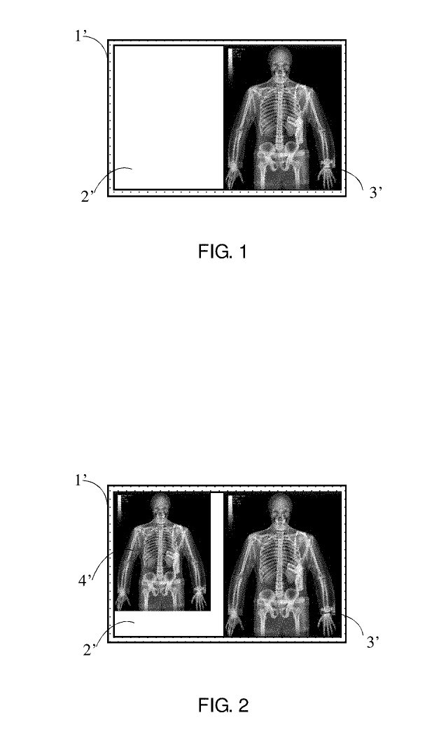

In the related art, some displays of medical display devices, in order to facilitate comparative view of the film and digital image displayed on the display, may be divided the screen thereof into two parts, as shown in FIGS. 1 and 2. Half of the display screen 1′ is set as a white image area 2′ for the light box mode for placing film, half is set as display 3′ for displaying digital image. However, when using this device, a placing position for a film 4′ and a displaying position of a digital image are limited at specific positions. Due to the different sizes of medical films, when viewing films of smaller size, an area extent of the light box may be larger than that of the film, which, on one hand, cannot make full utilization of the size of the display and cause waste of display area; and on the other hand, results in that a medical worker would be affected by negative effect light because of seeing a white image with high brightness on a periphery of the film due to light box mode, as shown in FIG. 2. The white image with high brightness will seriously irritate eyes of the medical worker, and cause the medical worker easy to copiopia, resulting in affecting their diagnostic accuracy or work efficiency.

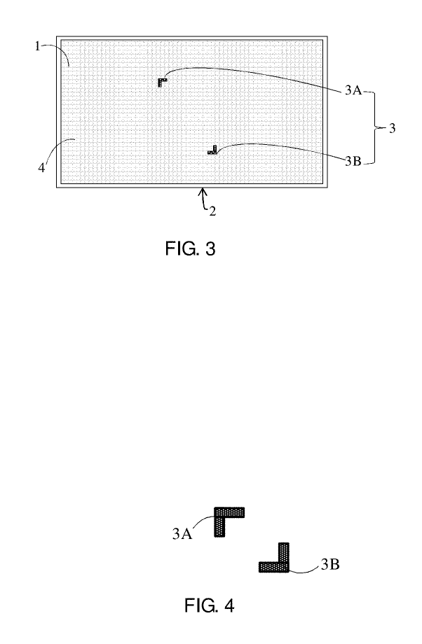

FIG. 3 is a schematic structural diagram of composition of a display portion of a display apparatus according to some embodiments of the present application. As shown in FIG. 3, the display apparatus includes a display screen 1, a display processor (not shown), a display apparatus housing frame 2, a fixing component 3 and a positioning sensor 4; where the fixing component 3 is configured to fix a to-be-exhibited object on the display screen; the positioning sensor 4 is configured to detect a position of the fixing component on the display screen; and the display processor is configured to determine a first area corresponding to the fixing component on the display screen according to the position detected by the positioning sensor, and switch an image displayed in the first area to a white image, wherein the first area includes an area on the display screen for placing the to-be-exhibited object. Where, the to-be-exhibited object may be a medical film, but is not limited thereto.

The display apparatus further includes an area dimmer (not shown) configured to adjust a brightness of a backlight corresponding to the white image. Where, the area dimmer may be further configured to adjust the brightness of the backlight corresponding to the white image according to a preset backlight brightness.

In some embodiments of the present application, the display processor is further configured to maintain a displayed image outside the first area unchanged. In some embodiments of the present application, the display processor is further configured to scale the displayed image to display in a second area outside the first area on the display screen. In response to there is a gap exists between the second region and the first region, the display processor is further configured to switch the gap to a preset grayscale image. In some embodiments, the display processor is further configured to switch the gap to a background image corresponding to a preset color according to a preset color or switch the gap to a background image corresponding to a preset pattern. For example, the preset color may include black, or dark blue, dark purple, etc., and the preset pattern may include the displayed image or the like, which will not be limited thereto.

In some embodiments of the present application, the fixing component is configured to fix the to-be-exhibited object through magnetic effect. In some embodiments of the present application, the fixing component is configured to fix the to-be-exhibited object through vacuum adsorption effect. Where, the way to fix the to-be-exhibited object by means of magnetic force or vacuum adsorption can be referred to the related art, which will not be repeated herein.

In some embodiments, the fixing component includes at least one fixing member. In some embodiments, as shown in FIG. 4, the fixing component includes at least two right-angled fixing members 3A and 3B. When the to-be-exhibited object is, for example, square, the at least two right-angled fixing members may be configured to fix the to-be-exhibited object along a diagonal position of the to-be-exhibited object.

The right-angled fixing members 3A and 3B are freely movable within the display apparatus housing frame 2. When it is not required to place the to-be-exhibited object, the fixing members may be placed outside the display 1 so as not to affect showing and viewing of the digital image displayed on the display. When the to-be-exhibited object is placed, the fixing members 3A and 3B are freely positioned at arbitrary positions on the display screen, and fix the to-be-exhibited object on the display screen at two angles along a diagonal of the to-be-exhibited object.

In some embodiments, the above fixing component may include at least one annular fixing component, and when the to-be-exhibited object is, for example, circular, the fixing component may be configured to fix the to-be-exhibited object along a circumference of the to-be-exhibited object; or, the fixing component may include a plurality of cylindrical fixing members, when the to-be-exhibited object, for example, has an irregular shape, the component may be configured to fix the to-be-exhibited object along a periphery of the to-be-exhibited object.

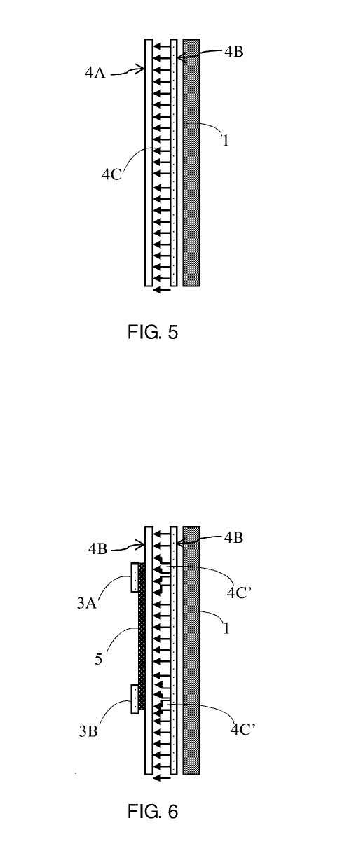

In some embodiments, the positioning sensor comprises an electric field sensing layer, the positioning sensor is configured to determine the position of the fixing component on the display screen by a electromagnetic induction effect or electric field effect of the electric field sensing layer. FIG. 5 is a schematic structural diagram of a positioning sensor according to some embodiments of the present application. As shown in FIG. 5, the positioning sensor 4 includes an electric field sensing layer 4C located between a surface 4A and a back 4B of the positioning sensor, and the positioning sensor 4 is flattened on a surface of the display screen 1. Where the electric field 4C may be a uniform electric field, but is not limited thereto.

In the following, referring to FIG. 6, Taking the case in which the to-be-exhibited object is a square medical film, the fixing component includes two right-angled magnetic fixing members as shown in FIG. 4, and the positioning sensor includes an electric field sensing layer as an example to illustrate the operation principle of the display apparatus. For the to-be-exhibited object is other objects rather than the medical film and has other shapes, the fixing component includes any other numbers of magnetic fixing members or the magnetic fixing members with other shapes or includes vacuum fixing members, the principle is similar, which will not be repeated herein.

When the film 5 is placed between the two fixing members, the electric field 4C between the device surface 4A and the back 4B where the fixing members are located, changes and becomes an electric field 4C′ due to a magnetic effect, therefore coordinates (xA, yA), (xB, yB) of the two fixing members 3A and 3B in the plane where the display screen is located may be obtained, respectively. Because the fixing members 3A and 3B are located at the apexes of the angles at both ends of the diagonal of the film, the obtained coordinates of the fixing members 3A and 3B are the coordinates of the apexes of the angles at both ends of the diagonal of the film, and the display processor is notified of the determined coordinates. The display processor, after receiving the coordinates, calculates coordinates corresponding to apexes of two angles of the other diagonal of the film, and then calculates an area of the area covered by the film (i.e., a first area) according to the coordinates of the apexes of the four angles of the film, and then the display processor switches the image displayed in the first area to a white image. The display processor may further notify the area dimmer of the calculated first area. The area dimmer, after receiving the first area provided by the display processor, adjusts a backlight brightness corresponding to the white image in the area, for example, turns on the light box mode as an observation light source for the film.

For example, when a medical worker places a film having a size of P×Q on an arbitrary position of the display screen 1 and fixes the film on the surface of the display screen using the fixing member 3, two points corresponding to the fixing members 3A and 3B are detected by the positioning sensor 4, and coordinates (xA, yA), (xB, yB) of the corresponding point are obtained, then the positioning sensor 4 notifies the display processor of these two coordinates. The display processor calculates that the coordinates of the four angles of the film are respectively (xA, yA), (xA, yB), (xB, yA) (xB, yB) based on the coordinates of the two points at positions along the diagonal, calculates that the length and the width of the film are P=|xB−xA|, Q=|yB−yA|, and an area of the area (i.e., the first area for placing the to-be-exhibited object) covered by the film is S=P*Q=|xB−xA|*|yB−yA|.

In some embodiments, the electric field sensing layer may be a capacitive touch screen, and the fixing component is a component that may be detected by the capacitive touch screen, which will not be limited herein.

The display processor, after determining the above coordinates and the area value, switches the displayed image of the first area corresponding to the coordinates and the area value to a white image. The display processor may further notify the area dimmer of the coordinates and the area value. The area dimmer, after receiving the coordinates and the area value provided by the display processor, may adjust, for example, raise, a brightness of a backlight corresponding to the area, so as to achieve an effect of light source as from a light box, for reading the film.

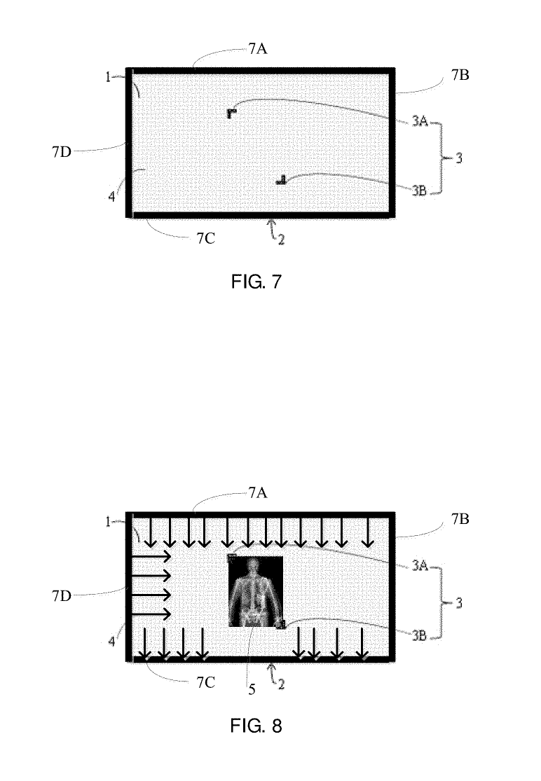

In some embodiments, the positioning sensor includes infrared sensing elements disposed opposite on a surface of the display screen, and the positioning sensor is configured to determine the position of the fixing component on the display screen by the infrared sensing elements. FIG. 7 is a schematic structural diagram of a positioning sensor according to some embodiments of the present application. As shown in FIG. 7, the positioning sensor 7 includes infrared sensing elements 7A and 7B, 7C, and 7D disposed along the housing frame 2 of the display screen 1, where the infrared sensing elements 7A, 7B are respectively disposed opposite to 7C, 7D. Where each of the infrared sensing elements may include an infrared emitting sensing element and/or an infrared receiving sensing element. In some embodiments of the present application, the infrared sensing elements 7A and 7B may respectively include an infrared emitting sensing element and a receiving sensing element, and the infrared sensing elements 7C and 7D may respectively include an infrared emitting sensing element and a receiving sensing element. In some embodiments, the above 7A, 7B, 7C and 7D may be integrated into one sensing element, for example, integrated as an infrared touch frame, which may be arranged in parallel with the surface of the display screen.

Referring to FIG. 8, taking the case in which the to-be-exhibited object is a square medical film, the fixing component includes two right-angled magnetic fixing components as shown in FIG. 4, and the positioning sensor includes infrared sensing elements as an example to illustrate the operation principle of the display apparatus. For the to-be-exhibited object is other objects rather than the medical film and has other shapes, the fixing component includes any other numbers of magnetic fixing members or the magnetic fixing members with other shapes or includes vacuum fixing members, the principle is similar, which will not be repeated herein.

When the film 5 is placed between the two fixing members, infrared rays emitted by a infrared sensing element, for example 7A, which may be received by the 7C disposed opposite thereto when not blocked by the film 5, however cannot be received by 7C due to being blocked by the film 5, so that a length 1 of the film can be detected. Similarly, the infrared rays emitted by 7B cannot be received by 7D when being blocked by the film, and thus another length w may be determined. In the same way, due to that the infrared sensing element cannot receive the infrared light emitted by the opposite end when being blocked by a fixing member, and thus the position of the fixing member can be determined.

In one embodiment, the infrared sensing element may send the detected positions and lengths to the display processor. The display processor, after receiving the positions and lengths detected by the infrared sensing elements, calculates an area of the area covered by the film (i.e., the first area), and then the display processor switches the image displayed in the first area to a white image. The display processor may further notify the area dimmer of the calculated first area. The area dimmer, after receiving the first area provided by the display processor, adjusts a backlight brightness corresponding to the white image in the area.

When a medical worker places a film having a size of P×Q on an arbitrary position of the display screen 1 and fixes the film on the surface of the display screen using the fixing member 3, the coordinates (xA, yA), (xB, yB) of the fixing members 3A and 3B, and the lengths P and Q of the film are detected by the positioning sensor 4 including the infrared sensing element, and then the positioning sensor 4 notifies the coordinates and the lengths detected to the display processor. The display processor calculates that the coordinates of the four angles of the film which are respectively (xA, yA), (xA, yB), (xB, yA) (xB, yB) based on the coordinates (xA, yA), (xB, yB) of the fixing members 3A and 3B which locates at the positions along the diagonal, and calculates that the area size of the area covered by the film (i.e., the first area for placing the to-be-exhibited object) is S=P*Q based on the lengths of the film.

The display processor, after determining the above coordinate positions and the area value, switches the displayed image in the first area corresponding to the coordinates and the area value to a white image. Optionally, the display processor may further notify the area dimmer of the coordinates and the area value. The area dimmer, after receiving the coordinates and the area value provided by the display processor, may adjust, for example, raise, a brightness of a backlight corresponding to the area, so as to achieve a effect of light source for film reading.

The display apparatus provided in embodiments of the present application, by fixing the to-be-exhibited object by the fixing component, and detecting the fixing component by the positioning sensor, a first area for displaying the to-be-exhibited object on the display screen can be automatically recognized, and by switching the display image of the first region to a white image, it achieves that the to-be-exhibited object can be displayed on the display screen without any key operation, and the medical worker may simultaneously reads the digital image and the to-be-exhibited object (including but not limited to film images) on the display screen, which facilitates the medical worker to perform lateral comparison, thereby improving diagnosis accuracy and work efficiency. Moreover, by fixing the to-be-exhibited object by the fixing component, the to-be-exhibited object may be placed freely, for example, in any manner that promotes reading for the medical worker, which further contributes to improvement of diagnostic accuracy and work efficiency. In addition, the above first area may be adaptively adjusted according to the size of the to-be-exhibited object, for example, which enables the digital image to be displayed over a larger area when the to-be-exhibited object is small, thereby improving the effective utilization of the display screen.

A display method that can be executed by the display apparatus will be described in detail below with reference to the display apparatus disclosed in the present application.

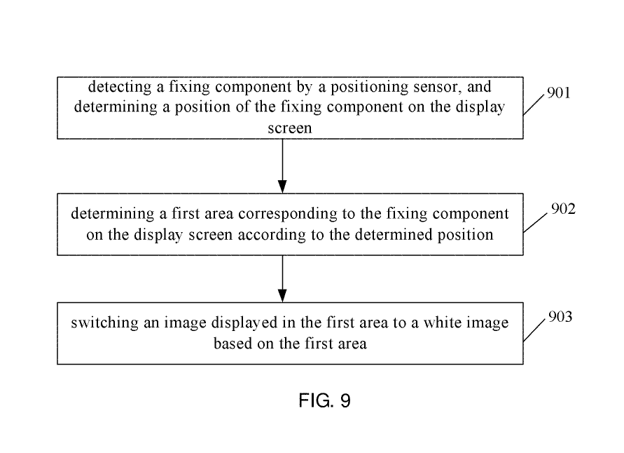

FIG. 9 is a flowchart of a display method according to some embodiments of the present application. As shown in FIG. 9, the display method includes the following steps:

Step 901: detecting a fixing component by a positioning sensor, and determining a position of the fixing component on a display screen, wherein the fixing component is configured to fix a to-be-exhibited object on the display screen;

Step 902: determining a first area corresponding to the fixing component on the display screen, according to the determined position, wherein the first area comprises an area on the display screen for placing the to-be-presented object; and,

Step 903: switching an image displayed in the first area to a white image based on the first area.

In some embodiments, the above display method may further include: adjusting a brightness of a backlight corresponding to the white image by an area dimmer.

the above display method may further include: adjusting the brightness of the backlight corresponding to the white image according to a preset brightness by the area dimmer.

In some embodiments, the positioning sensor includes an electric field sensing layer, and step 901 includes: detecting the fixing component by the electric field sensing layer, and determining the position of the fixing component on the display screen.

In some embodiments, the positioning sensor includes an infrared sensing element, and step 901 includes: detecting the fixing member by the infrared sensing element, and determining the position of the fixing component on the display screen.

In the method embodiment, the operation principle and technical effects may be referred to the content description related to the foregoing display apparatus, which will not be repeated herein.

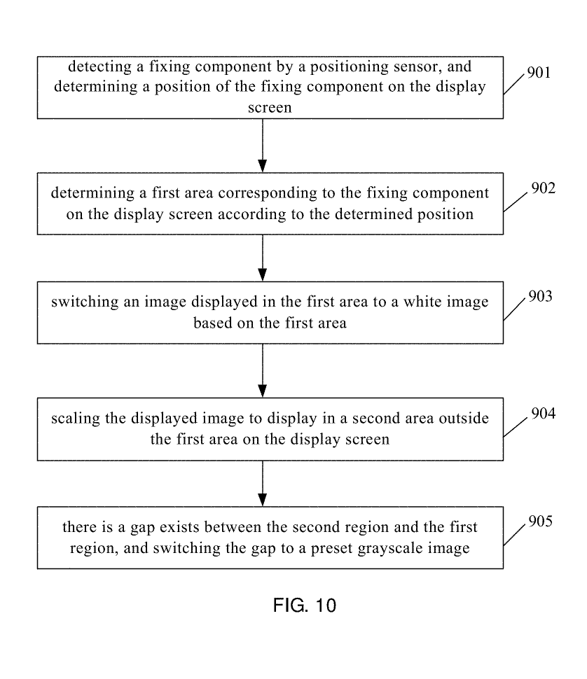

FIG. 10 is a flowchart of a display method according to some embodiments of the present application. As shown in FIG. 10, the embodiment of the display method, in comparison with FIG. 9, further includes the following steps in addition to the steps 901-903:

Step 904: scaling the displayed image to display in a second area outside the first area on the display screen; and

Step 905: in response to there is a gap exists between the second region and the first region, and switching the gap to a preset grayscale image.

In some embodiments, the display processor is further configured to switch the gap to a background image corresponding to a preset color according to a preset color, or switch the gap to a background image corresponding to a preset pattern.

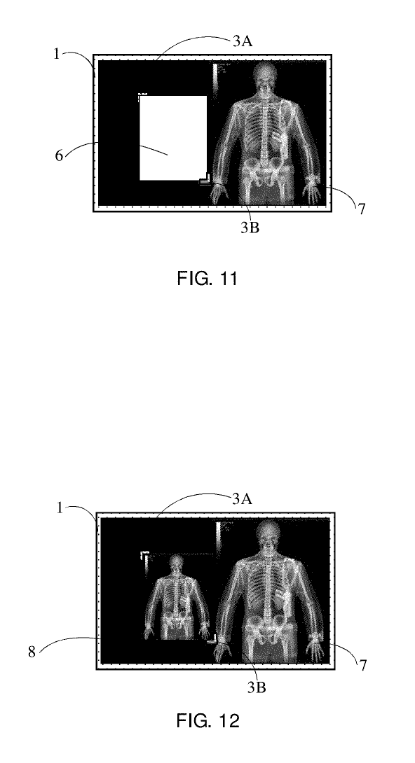

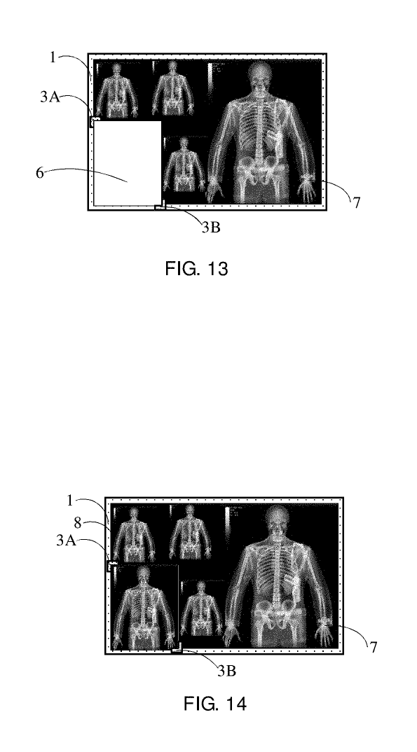

The operation schematic diagram of the display apparatus performing the display method, in some embodiments, in case that the gap is switched to the preset grayscale color, is as shown in FIG. 11 and FIG. 12, where FIG. 11 is a schematic operation diagram of the display apparatus according to the display method shown in FIG. 10 placing a fixing component without an to-be-exhibited object thereon, and FIG. 12 is a schematic operation diagram of the display apparatus according to the display method shown in FIG. 10 placing a fixing component with the to-be-exhibited object thereon. The operation schematic diagram of the display apparatus performing the display method, in some embodiments, in case that the gap is switched to a preset pattern, is as shown in FIG. 13 and FIG. 14, where FIG. 13 is another schematic operation diagram of the display apparatus according to the display method shown in FIG. 10 placing a fixing component without an to-be-exhibited object thereon, and FIG. 14 is another schematic operation diagram of the display apparatus according to the display method shown in FIG. 10 placing a fixing component with the to-be-exhibited object thereon.

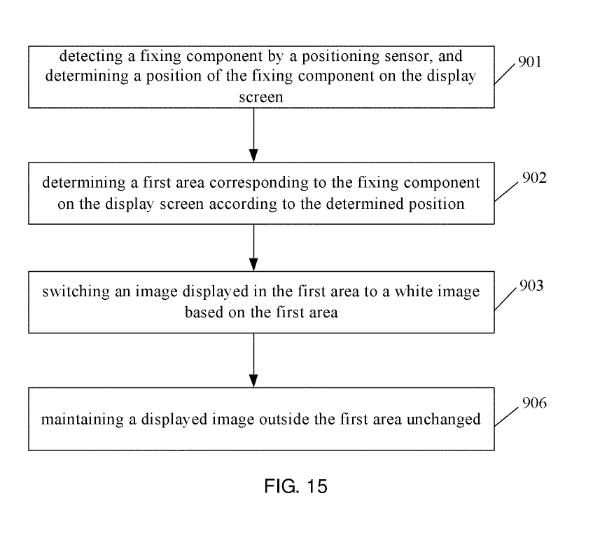

FIG. 15 is a flowchart of a display method according to some embodiments of the present application. As shown in FIG. 15, the embodiment of the display method, in comparison with FIG. 9, further includes the following step in addition to the steps 901-903:

Step 906: maintaining a displayed image outside the first area unchanged.

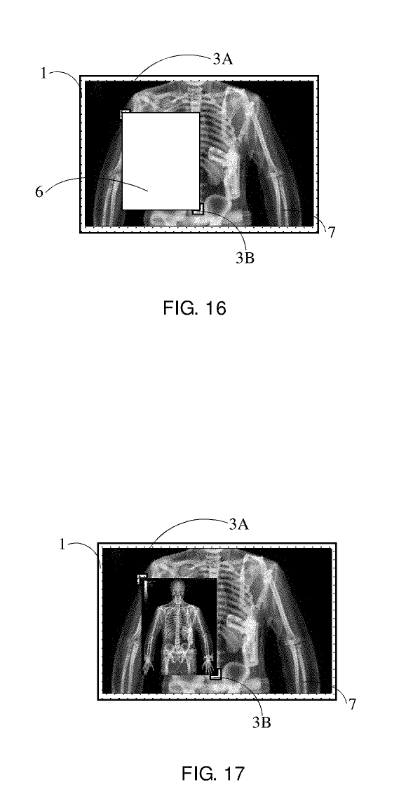

The operation schematic diagram of the display apparatus performing the display method, in some embodiments, in case that the gap is switched to a preset grayscale color, is as shown in FIG. 16 and FIG. 17, where FIG. 16 is a schematic operation diagram of the display apparatus according to the display method shown in FIG. 15 placing a fixing component without an to-be-exhibited object thereon, and FIG. 17 is a schematic operation diagram of the display apparatus according to the display method shown in FIG. 15 placing a fixing component with the to-be-exhibited object thereon.

The display method provided in embodiments of the present application, by fixing the to-be-exhibited object by the fixing component, and detecting the fixing component by the positioning sensor, a first area for displaying the to-be-exhibited object on the display screen can be automatically recognized, and by switching the display image of the first region to a white image, it achieves that the to-be-exhibited object can be displayed on the display screen without any key operation, and the medical worker may simultaneously reads the digital image and the to-be-exhibited object (including but not limited to film images) on the display screen, which facilitates the medical worker to perform lateral comparison, thereby improving diagnosis accuracy and work efficiency. Moreover, by fixing the to-be-exhibited object by the fixing component, the to-be-exhibited object may be placed freely, for example, in any manner that promotes reading for the medical worker, which further contributes to improvement of diagnostic accuracy and work efficiency. In addition, the above first area may be adaptively adjusted according to the size of the to-be-exhibited object, for example, which enables the digital image to be displayed over a larger area when the to-be-exhibited object is small, thereby improving the effective utilization of the display screen.

The above descriptions is merely for facilitating those skilled in the art to understand the technical solutions of the present application, and is not intended to limit the present application. For those skilled in the art, any amendments, equivalent substitutions, improvement and the like made without departing from the principle of the present application should be included in the protection scope of the present application.

What is claimed is:

1. A display apparatus, comprising a display screen, further comprising: a fixing component, a positioning sensor, and a display processor; wherein
the fixing component is configured to fix a to-be-exhibited object on the display screen;
the positioning sensor is configured to detect a position of the fixing component on the display screen;
the display processor is configured to determine a first area corresponding to the fixing component on the display screen according to the position detected by the positioning sensor, and switch an image displayed in the first area to a white image, wherein the first area includes an area on the display screen for placing the to-be-exhibited object.

2. The display apparatus of claim 1, further comprising: an area dimmer, configured to adjust a brightness of a backlight corresponding to the white image.

3. The display apparatus of claim 2, wherein the area dimmer is configured to adjust the brightness of the backlight corresponding to the white image according to a preset backlight brightness.

4. The display apparatus of claim 1, wherein the positioning sensor comprises an electric field sensing layer, the positioning sensor is configured to determine the position of the fixing component on the display screen by an electromagnetic induction effect of the electric field sensing layer.

5. The display apparatus of claim 1, wherein the positioning sensor comprises infrared sensing elements disposed oppositely on a surface of the display screen, and the positioning sensor is configured to determine the position of the fixing component on the display screen by the infrared sensing elements.

6. The display apparatus of claim 1, wherein the display processor is further configured to maintain a displayed image outside the first area unchanged.

7. The display apparatus of claim 1, wherein the display processor is further configured to scale the displayed image to display in a second area outside the first area on the display screen.

8. The display apparatus of claim 7, in response to there is a gap exists between the second region and the first region, the display processor is further configured to switch the gap to a preset grayscale image.

9. The display apparatus of claim 1, wherein the fixing component is configured to fix the to-be-exhibited object through magnetic effect or vacuum adsorption effect.

10. The display apparatus of claim 1, wherein the fixing component comprises at least two right-angled fixing members.

11. The display apparatus of claim 10, wherein the at least two right-angled fixing members are configured to fix the to-be-exhibited object at positions along a diagonal of the to-be-exhibited object.

12. The display apparatus of claim 1, wherein the fixing member comprises an annular fixing member.

13. The display apparatus of claim 1, wherein the to-be-exhibited object is a film.

14. A display method, comprising:
detecting a fixing component by a positioning sensor, and determining a position of the fixing component on a display screen, wherein the fixing component is configured to fix a to-be-exhibited object on the display screen;
determining a first area corresponding to the fixing component on the display screen according to the determined position, wherein the first area comprises an area on the display screen for placing the to-be-presented object;
switching an image displayed in the first area to a white image based on the first area.

15. The display method of claim 14, further comprising: adjusting a brightness of a backlight corresponding to the white image by an area dimmer.

16. The display method according to claim 14, wherein the positioning sensor comprises an electric field sensing layer, and the detecting the fixing component by the positioning sensor, and determining the position of the fixing component on the display screen comprises:
detecting the fixing component by the electric field sensing layer, and determining the position of the fixing component on the display screen.

17. The display method of claim 14, wherein the positioning sensor comprises infrared sensing elements disposed oppositely on a surface of the display screen, and the detecting the fixing component by the positioning sensor, and determining the position of the fixing component on the display screen comprises:
detecting the fixing member by the infrared sensing elements, and determining the position of the fixing component on the display screen.

18. The display method of claim 14, further comprising: scaling the displayed image to display in a second area outside the first area on the display screen.

19. The display method of claim 18, in response to there is a gap exists between the second region and the first region, the method further comprises: switching the gap to a preset grayscale image.

20. The display method of claim 14, further comprising: maintaining a displayed image outside the first area unchanged.
